(19) United States
(12) Patent Application Publication
(10) Pub. No.: US 2009/0311123 A1
(43) Pub. Date: Dec. 17, 2009

(54) METHOD FOR PRODUCING METAL ALLOY AND INTERMETALLIC PRODUCTS

(75) Inventors: Deliang Zhang, Hamilton (NZ); Stiliana Rousseva Raynova, Hamilton (NZ)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: WAIKATOLINK LIMITED, Hamilton (NZ)

(21) Appl. No.: 12/303,098

(22) PCT Filed: May 31, 2007
(86) PCT No.: PCT/NZ07/00133

§ 371 Date: Jul. 21, 2009

(30) Foreign Application Priority Data
May 31, 2006 (NZ) 547608

(51) Int. Cl. B22F 3/12; B32B 15/02

(52) U.S. Cl. 419/19; 75/235

(57) ABSTRACT

This invention relates to a method for producing alloy and intermetallic powders. Particularly to a method for the production of titanium based alloy and intermetallic powders. A first metal and a second metal oxide powder are mixed with a controlled metal/metal oxide molar ratio. This mixture is heated, becomes self propagating and leads to formation of a mixture of alloy liquid and a oxide solid. Pressure is applied to separate the phases and upon cooling produces a metallic solid. FIG. 1a shows an example of a solid crushed into a powder as produced by this method.

### TECHNICAL FIELD

This invention relates to a method for producing alloy and intermetallic products. Particularly, although not exclusively the present invention relates to a method for the production of titanium based alloy and intermetallic products.

### BACKGROUND ART

Pure titanium is a silvery-white, lustrous metal with a low density and good strength. Titanium alloys which are formed by combining titanium with a small fraction of other metals can be as strong as high strength steel, but with only 60% of its weight.

Titanium and its alloys are ideal for applications in which weight is important, since the alloys have greater strength to weight ratio than other metal alloys. Because of its high strength to weight ratio, titanium and its alloys are widely used in both aerospace and non-aerospace applications.

Aerospace applications include use in gas turbine engines in both military and commercial aircraft (where use of titanium results in reduced engine weight while maintaining strength). In most aircraft engines, titanium-based alloy parts account for 20% to 30% of engine weight.

Aerospace uses for titanium constitute the largest market for titanium, with commercial and military aerospace applications consuming 65% of titanium mill product shipments in 1997.

Non-aerospace applications include use in specialty chemical, pulp and paper, oil and gas, marine and consumer goods industries.

Titanium alloys can also be used to replace steel in making automotive components, but this application has been severely limited by the high cost of titanium alloys.

This high cost is largely a result of the expensive batch processes that are used to recover titanium from its mineral concentrates, and the technical difficulties associated with melting and alloying titanium. When in molten form, titanium has an extremely high tendency to react with surrounding materials and the atmosphere which causes difficulties in processing titanium alloys in molten form.

The conventional titanium production process, the Kroll process, involves the reaction of TiO₂ and carbon, in the form of coke, under chlorine gas at temperatures of 800° C. to form TiCl₄ and carbon monoxide.

The titanium chloride (TiCl₄) produced by this reaction exists as a liquid and has to be purified by distillation. The liquid is introduced into a furnace holding a magnesium melt at 680° C. to 750° C. to facilitate the formation of magnesium chloride (MgCl₂) and pure titanium.

MgCl₂ is a gas, while titanium is a solid sponge. Titanium sponge is a porous, brittle form of titanium. Sponge is an intermediate product used to produce titanium ingots, which in turn is used to make slabs, billets, bars, plates, sheets, and other titanium mill products.

The sponge is purified by distillation or leaching using hydrochloric acid. The magnesium chloride can be recycled through an electrolysis process.

The titanium sponge that is formed by this process can be further processed to produce commercial purity titanium or titanium alloys by vacuum arc melting or other melting methods.

If titanium or titanium alloy powder is needed, the titanium or titanium alloy needs to be heated to a high temperature above 1650° C. to produce titanium alloy melt and the alloy melt is atomised into liquid droplets which in turn solidifies as powders.

The limitations of this process include its complexity and the use of chlorine. The process involves several high temperature steps where a high amount of energy is needed. This contributes to the high cost of titanium and titanium alloys. The use of chlorine makes the process environmentally unfriendly.

U.S. Pat. No. 6,264,719 discloses both a titanium alloy based dispersion-strengthened composite and a method of manufacture of same. This patent discloses the use of dry high-energy intensive mechanical milling and the process of producing titanium base metal matrix composites (MMC).

High energy mechanical milling has the effect of providing the necessary number of small particles below the micrometer size range as well enhancing the reactivity of different particles with one another.

While this patent has provided a method of producing titanium based MMCs at a reduced cost, it does not disclose a method for separating out unwanted components present within the MMC or adjusting the level of certain components to more desirable concentrations. It would be an advantage of the present state of the art to have some way of removing unwanted components.

JP20019211A2 discloses the production of hydrogen-containing titanium-aluminium alloy powder.

Sieved sponge titanium of about ≦50 mm is charged into a furnace and is heated at 300° C. to 500° C. for one minute to one hour in a hydrogen current under about 1 to 5 atmospheric pressure. This sponge titanium is subjected to the hydrogen absorbing treatment contains ≧3.5 mass % hydrogen and has a 1 to 20 mm grain size. The sponge titanium which has been subjected to the hydrogen absorbing treatment is charged into a vessel together with aluminium powder, grains or pieces, and the mixture is subjected to ball milling by using a rotary ball mill or the like. The ball milling is executed in an atmosphere of inert gas or in a vacuum. By the milling for about 10 to 200 hours, an alloy powder in which aluminium and hydrogen are allowed to enter into solid solution of a titanium can be obtained.

However, this process uses high cost raw materials (sieved sponge titanium) to make the hydrogen-containing titanium rich intermetallic or alloy powders directly. This leads to high cost for production of the titanium intermetallic and alloy powder.

Other than the specific methods as described above, there are also several other well established methods for producing metal and alloy powders which can be used to produced titanium or other metal and alloy powders. These include (a) liquid-atomisation method; (b) electrolytic method; (c) reduction method; and (d) grinding method.

The liquid-atomisation method involves preparing a metal or alloy melt by melting pure metals or alloys. A stream of the melt is then broken into droplets using gas, water, centrifugal forces or other means. The droplets subsequently solidify into fine solid particles in an inert environment such as argon or vacuum to procured powders. The disadvantage of this method is that titanium alloy powders produced are very expensive because of the high cost of the starting titanium metal or alloy and high processing cost.

The electrolytic method involves using an electrolytic cell and suitable anode and cathode materials and electrolytes that can be operated in such away that metals or alloys particles can be produced at the cathode side. As an example, an extension of this method which has been applied to producing titanium metal powder is the well documented FFC-Cambridge process which involves de-oxidation of TiO₂ powder compact into a compact of titanium powder using the electrolytic process.

The difficulty of this method to directly produce titanium alloy or titanium based intermetallic powders is the complexity involved in simultaneously reducing different oxides in an electrolytic process.

The reduction method is often used to produce not so active metal or alloy powders by reducing a chemical powder such as iron oxide (FeO, Fe₂O₃ or Fe₃O₄) and copper oxide (CuO) by a suitable reductant chemical such as carbon or hydrogen to produce a metal powder. One extension of the reduction powder method is the widely reported Armstrong process where TiCl₄ gas is continuously reduced by a flow of molten sodium to produce titanium powder. The Armstrong process is similar to the Kroll process in terms of having to involve the use of chlorine which is corrosive and environmentally unfriendly. It is also difficult to use these methods to directly produce titanium alloy and titanium based intermetallic powders because of the complexity of the reduction process.

It would be an advantage over the present state of art to have some method which uses low cost raw materials which can lead to production of low cost titanium intermetallic and alloy powders and can be more easily developed into a large scale industrial process which is more energy efficient and environmentally friendly.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a method of producing an alloy including the steps of:
a) pressing a milled metal I metal oxide composite powder producing a powder compact, and
b) inserting the powder compact in an open die or an extrusion die, and characterised by the steps of:
c) applying pressure to the powder compact, and
d) heating the powder compact in the die to the required temperature such that exothermic reactions between the metal and metal oxide in the powder compact is ignited, become self propagating and lead to formation of a mixture of alloy liquid and oxide solid, and
e) continuing to apply pressure to separate phases.

Preferably, the steps above may include milling the mixture to produce the metal/metal oxide composite powder.

Preferably, the steps above may include mixing a first and a second metal oxide powder with a controlled metal/metal oxide ratio to form a mixture to be milled.

Preferably, pressure may be applied by pressing or extruding the solid/liquid mixture to separate the molten intermetallic or metallic phases of the metal rich intermetallic or metallic liquid from the solid metal oxide phase or other ceramic phases, producing metallic or intermetallic lumps or ingots.

Throughout the present specification the term ‘metal based alloy’ in accordance with the present invention should be understood to mean a metallic material consisting of a mixture of at least two metals or of metallic with non-metallic elements. While it should be appreciated that there is at least two substances in a metal based alloy, there is theoretically no limit to the number of substances that make up a metal based alloy. This term may now be simply referred to as an alloy.

In preferred embodiments of the present invention the metal in the metal based alloy is predominantly titanium.

However, this should not be seen as a limitation on the embodiments envisaged for this invention. The metals that predominantly make up the metal based alloy can include preferably nickel, platinum, aluminium, palladium and possibly any others from the periodic table. The starting materials can include oxides and other ceramic materials.

It should be appreciated to those skilled in the art that an intermetallic powder is a substance that contains one or more metal compounds divided into many small individual particles.

In preferred embodiments, the reaction products are titanium rich intermetallic compounds TiAl, and/or Ti₃Al or metallic phases such as Ti(Al) solution and Al₂O₃

For ease of reference throughout the specification, TiAl and Ti₃Al will now be collectively referred to as TiₓAl. This term should not be seen as limiting.

An advantage of this method is that it uses low cost raw material such as Al and TiO₂ to synthesise titanium rich metallic or intermetallic powders directly, which can lead to the production of low cost titanium based metallic or intermetallic powders.

Specifically, a first metal such as Al and a second metal oxide powder such as TiO₂ are mixed together with an Al/TiO₂ molar ratio which can be controlled using one of the following nominal reaction equations:

4Al+3TiO₂→0.3Ti+2Al₂O₃ (1)

5Al+3TiO₂→Ti₃Al+2Al₂O₃ (2)

7Al+3TiO₂→3TiAl+2Al₂O₃ (3)

There are other Al/TiO₂ molar ratios that can be utilised.

Depending on the Al/TiO₂ molar ratio, the reaction products are titanium rich metallic and/or intermetallic phases and Al₂O₃.

In preferred embodiments the molar ratio of Al:TiO₂ for the production of the titanium rich intermetallic compound TiAl is 7:3.

The molar ratio of Al:TiO₂ for the production of the titanium rich intermetallic compound Ti₃Al is 5:3.

A further metallic phase of Ti(Al) solution may be produced by the Al:TiO₂ molar ratio of 4:3.

The mixture is converted into an Al/TiO₂ composite powder or an Al/TiO₂ powder mixture with particle sizes in a typical range of 0.1 μm-200 μm.

The powder is mixed and milled by a milling means in order to create a powder with a high area of reaction interfaces. The milling time typically ranges from 1 minute to 100 hours.

In preferred embodiments the milling means may be a high-energy mechanical mill such as a ball mill or a discus mill.

This is a mechanical process in which the mixture of the metallic powder and oxide powder is treated to alter the shape, size and microstructure of the particles through the impact of milling balls or discus typically made of hardened steel upon the powder particles within a container also typically made of steel hardened steel.

In some embodiments, the milling of the powder is undertaken under an inert environment. This could include an inert atmosphere such as argon, or a vacuum.

The milled Al/TiO₂ composite powder or powder mixture is pressed into a powder compact of variable shape and size using a mechanical press and a metal or ceramic die.

The term ‘powder compact’ is a term known to someone with skill in the art of powder metallurgy and refers to compressing a metal powder to form a powder agglomerate suitable for sintering.

In preferred embodiments of the present invention the shape and configuration of the powder compact may be typically a cylinder of 40 mm in diameter and 40 mm in height.

However, this should not be seen as a limitation on the embodiments envisaged for this invention. A number of sizes and shapes may be used to produce the powder compact depending on the processing requirements.

Preferably, the strength of the compact should be sufficient to allow a light pressure typically in the range of 0.01-15 MPa being applied to the compact in an open die without causing the compact to fracture or collapse at temperatures up to the ignition temperature of the compact.

It is envisaged that the shape of the compact may have features such as a centre hole and/or surface grooves which can assist the liquid flowing out of the compact in the later stage of the process.

The powder compact is placed in either an open die or an extrusion die, and a light pressure typically in the range of 0.01-15 MPa is applied to the compact. An open die is known to someone with the skill in the art of metallurgy and refers to a die configuration typically consisting of two pieces with typically flat working surfaces. Open dies with non-flat working surfaces may be used to assist the solid-liquid separation in later stage of the process.

An extrusion die is also known to someone with the skill in the art of metallurgy and refers to a die configuration typically consisting of a piece with a cavity of controlled size and shape and an outlet opening of controlled size and shape and a plunger. The dies may be made from heat resistant materials such as alumina, tungsten carbide, silicon carbide, H13 die steel or other high temperature ceramic or metallic materials.

The die containing the powder compact is heated to an elevated temperature using a heater or a furnace under an inert atmosphere of argon or helium or in a vacuum. This elevated temperature is typically in the range of 400° C.-1300° C.

In preferred embodiments the die and the heater or furnace are surrounded with insulation material such as alumina particle board to protect loss of heat.

In preferred embodiments the powder compact is heated to the temperature required to ignite the exothermic reactions between the metal and oxide in the powder compact while the powder compact is being pressed with a light pressure typically in the range of 0.01-15 MPa.

This temperature which is typically in the range of 400° C.-1300° C. ignites the powder compact and allows an exothermic reaction between Al and TiO₂ to take place and become self propagating. The ignition temperature of the powder compact depends on the composition, size and microstructure of the powder particles in the composite and the degree of powder compaction in the compact. Typically the ignition temperature can be measured by conducting thermal analysis of the composite powder or powder compact.

It is envisaged that the ignition of the of the compact is high enough so that the heat generated from the self-propagating reaction is sufficient to heat the reaction products to a temperature above the melting point of the metallic or phases, and also allow the melt to stay for a sufficiently long time to allow at least a substantial portion of it to be squeezed out of the solid/liquid mixture. Typically, a higher ignition temperature can lead to an increase of the fraction of the liquid to be separated out from the solid/liquid mixture.

The advantages of this invention is that it generates so much heat at a sufficiently high rate that it heats the reaction products to a temperature which is above the melting point of titanium rich metallic or intermetallic phases, but below the melting point of Al₂O₃. A solid/liquid mixture allows the separation process of Al₂O₃ from the titanium rich metallic or intermetallic phases to be more effective and less expensive.

The combustion reaction used to produce TiₓAl from aluminium and titanium dioxide powders results in the formation of Al₂O₃ particles and a titanium rich metallic or intermetallic phase.

While Al₂O₃ is a desired component of a metal-ceramic composite e.g. TiₓAl_{y}(O)/Al₂O₃, it is often desirable to separate the Al₂O₃ phase in order to produce high value titanium base metallic or intermetallic material such as Ti₃AI.

Once the titanium rich intermetallic or metallic phases melt and turns into a molten titanium alloy, the mixture of titanium alloy liquid and Al₂O₃ solid is able to be separated by pressing of the solid/liquid mixture.

In preferred embodiments the separation process may be performed by pressing the solid/mixture using an open die or extruding the solid/liquid mixture using an extrusion die. The pressing or extruding action enables the molten titanium to flow easily out of the mixture.

An advantage of the die apparatus is that it allows the liquid to flow easily out of the mixture. In this way, the titanium rich intermetallic or metallic liquid is separated from the Al₂O₃ phase.

An advantage of the separation process is that the solid/liquid separation provides a degree of purification resulting in the titanium rich powder being pure enough for some applications.

In preferred embodiments of the present invention upon flowing out of the solid/liquid mixture and cooling, the molten titanium alloy solidifies and turns into titanium rich intermetallic compounds and/or metallic phases in the ingot, granule or lump form. The initial cooling of the molten titanium alloy occurs rapidly once it flows to a lower temperature zone. Further cooling may be done by switching off the heat or furnace and leaving the titanium rich ingot, granules or lumps to set, or by using flowing argon.

The ingot, granules or lumps may be crushed into a titanium rich powder containing less than 10% oxygen in weight. The ingot is fairly brittle owing to this oxygen content and therefore is easily crushed.

In preferred embodiments the present invention the ingot may be crushed by using a ball mill or a discus mill.

There are a number of advantages associated with this method. The method allows the use of lower grade and therefore lower cost raw materials (Al and TiO₂) to make the titanium rich intermetallic or alloy powders.

For example, TiO₂ may be obtained from slag which contains approximately 30-35 molar percent of TiO₂ or enriched slag with a TiO₂ content of 80 molar percent or higher.

This leads to the production of low cost titanium alloy and intermetallic powders.

The method utilises the formation of a solid/liquid mixture through a controlled self-propagated exothermic reaction. This allows pressing of the solid/liquid mixture to separate the titanium rich phase and the ceramic phase.

The advantage of this separation process is that it allows a very quick and easy separation of components compared to known and existing prior art methods. The decrease in the number of steps and the ease of same leads to lower costs for the separation procedure.

A further advantage of the separation process is that the solid/liquid separation provides a degree of purification resulting in the titanium rich powder being pure enough for some applications.

Yet a further advantage of the solid/liquid separation process is that it can be used to produce alloys containing three or more metallic alloying elements such as Ti—Al—V alloys. As an example, when the production of such complex alloys or intermetallic compounds is desired, the initial Al/TiO₂ powder mixture or composite powder and the corresponding powder compact needs to contain a required portion of other metal oxide (or oxides) such as V₂O₅. This method allows the metal oxide to be reduced by the metal constituent such as Al to produce alloys containing three or more metallic alloying elements.

### BRIEF DESCRIPTION OF DRAWINGS

Further aspects of the present invention will become apparent from the following description which is given by way of example only and with reference to the accompanying micrographs and graphs in which:

FIG. 1 (a) The microstructure of the intermetallic compound TiAl as produced by this method; (b) Energy dispersive X-ray (EDX) spectrum from the TiAl phase of the microstructure showing the composition of this phase; (c) X-ray diffractometry (XRD) pattern of the intermetallic compound TiAl as produced by this method (The small fraction of inclusion particles (<5%) are Al₂O₃);

FIG. 2 (a) The microstructure of the intermetallic compound Ti₃Al as produced by this method; (b) Energy dispersive X-ray (EDX) spectrum from the Ti₃Al phase of the microstructure showing the composition of the phase; (c) X-ray diffractometry (XRD) pattern of the intermetallic compound TiAl as produced by this method (The small fraction of inclusion particles (<5%) are Al₂O₃);

FIG. 3 (a) The microstructure of the metallic Ti(Al) solid solution as produced by this method; (b) Energy dispersive X-ray (EDX) spectrum from the Ti(Al) phase of the microstructure showing the composition of the phase (The small fraction of inclusion particles (<5%) are Al₂O₃.);

FIG. 4 (a) The microstructure of the metallic Ti(Al,V) alloy as produced by this method; (b) Energy dispersive X-ray (EDX) spectrum from the Ti(Al,V) phase of the microstructure showing the composition of the phase (The small fraction of inclusion particles (<5%) are Al₂O₃.); and

FIG. 5 Cross-sections of the particles in the intermetallic compound TiAl powder produced by mechanical crushing of the intermetallic compound TiAl granules produced using this method.

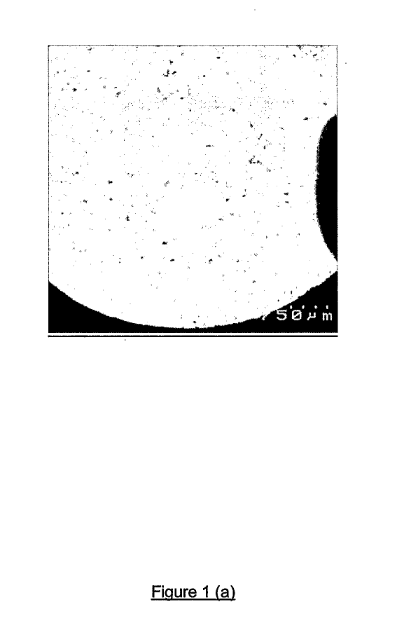

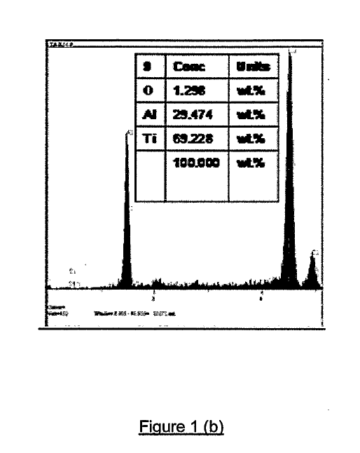

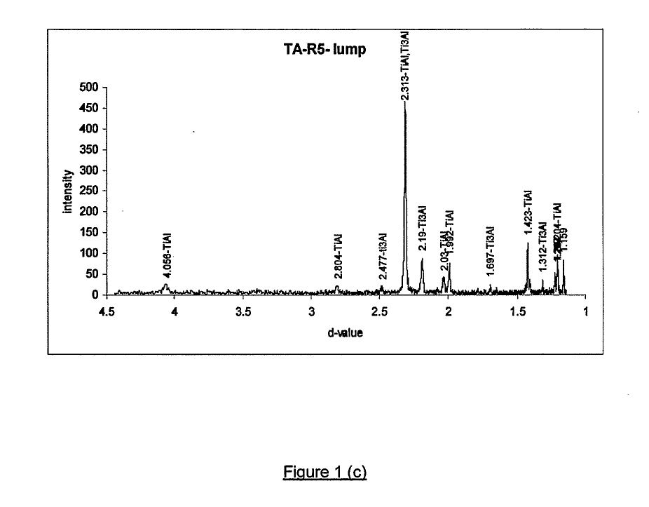

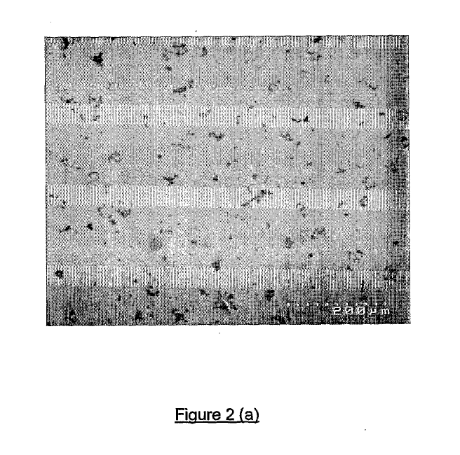

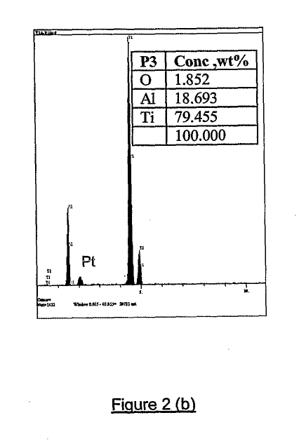

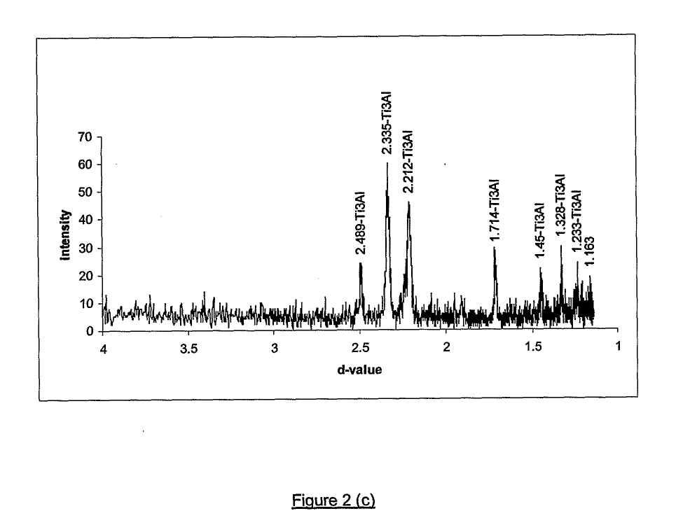

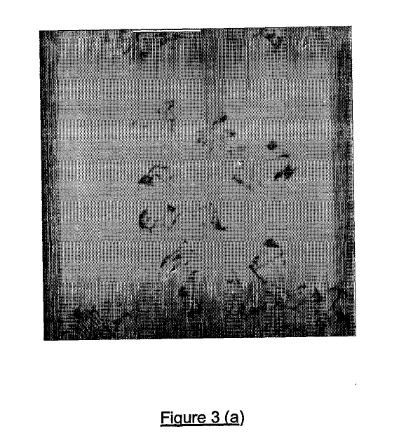

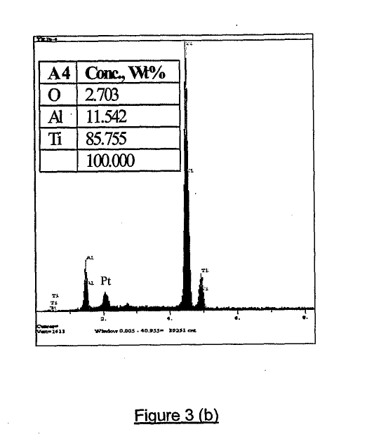

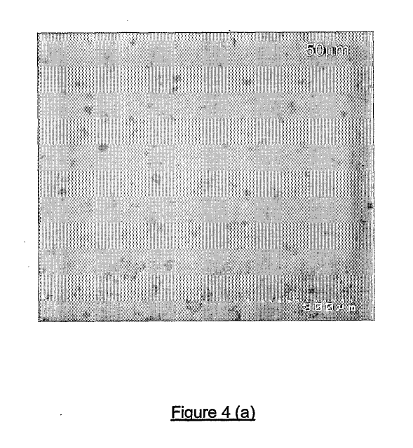

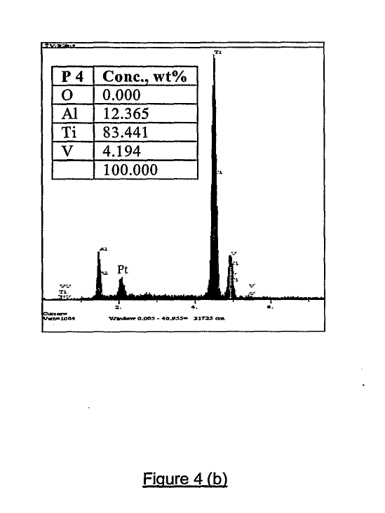

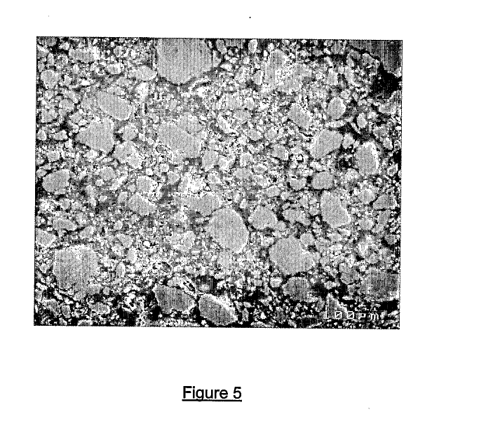

### BEST MODES FOR CARRYING OUT THE INVENTION

The steps detailed below utilise Al and TiO₂ powders as starting materials and disclose the method of producing Ti—Al alloy or TiₓAl_{y} intermetallic powders.

### Step 1: Mixture of Reactants

The Al and TiO₂ powders with a controlled Al/TiO₂ molar ratio are added together into a container. The molar ratio between Al and TiO₂ can be controlled depending on the desired product according to one of the following nominal expressions:

For producing intermetallic compound TiAl

7Al+3TiO₂→3TiAl+2Al₂O₃ (1)

For producing intermetallic compound Ti₃Al

5Al+3TiO₂→Ti₃Al+2Al₂O₃ (2)

For producing metallic phase Ti(Al) solution

4Al+3TiO₂→3Ti+2Al₂O₃ (3)

### Step 2: Milling

The mixture of Al and TiO₂ powders is milled to increase the Al/TiO₂ interface area for reaction using a high-energy mechanical mill under argon or other inert atmosphere including vacuum. The milling time is 2-4 hours. After milling, the Al/TiO₂ powder mixture is turned into Al/TiO₂ composite powder.

### Step 3: Compaction

The milled Al/TiO₂ composite powder is pressed into a powder compact typically with a cylindrical shape of 40 mm in diameter and 30 mm in height first using a H13 tool steel die and a press at a pressure of 10-50 MPa and subsequently using a cold isostatic press at a pressure of 200 MPa.

### Step 4: Reaction Preparation

The powder compact is placed between two alumina plates of 5-10 mm in thickness, and then the stack is placed between the bottom work piece and the plunger of an open die which is made of H13 steel and controlled at room temperature. This set-up is enclosed in a chamber which allows the evacuation and back-fill argon. The chamber is surrounded with an electrical heater for heating and insulation material to prevent loss of heat. After this set-up is completed, a pressure in the range of 0.1-15 MPa is applied to the plunger of the open die and the pressure is maintained.

### Step 5 Self Propagation Reaction and Separation

The powder compact together with the open die is heated, and when the compact is heated to a temperature in the range of 650-700° C. for the powder compact with an Al/Ti₂ molar ratio controlled by equation (1) for producing TiAl, or a temperature in the range of 700-800° C. for the powder compact with an Al/TiOs molar ratio controlled by Equation (2) or (3), the exothermic reaction between Al and TiO₂ in the powder compact is ignited and becomes self propagating. Depending on the Al/TiO₂ molar ratio, the reaction products are titanium rich intermetallic compounds (e.g. TiAl, and/or Ti₃Al) or metallic phases (e.g. Ti(Al) solution) and Al₂O₃.

The reaction generates so much heat at a sufficiently high rate that it heats the reaction products to a temperature which is above the melting point of titanium rich intermetallic or metallic phases solution, but below the melting point of Al₂O₃. Once the titanium rich intermetallic or metallic phase melts it turns into a molten titanium alloy. Since the powder compact is being pressed by the plunger, the mixture of titanium alloy liquid and Al₂O₃ solid is squeezed. The squeeze action causes part of the molten titanium alloy to flow out of the mixture, and therefore is separated from the Al₂O₃ phase.

### Step 7 Cooling and Crushing

Upon cooling, the molten titanium alloy solidifies and turns into titanium rich intermetallic compounds and/or metallic phases in often granules or ingot form. The ingot or granules are subsequently crushed into a titanium rich intermetallic or metallic powder. Since the material is fairly brittle due to its substantial oxygen content the crushing is easy.

Aspects of the present invention have been described by way of example only and it should be appreciated that modifications and additions may be made thereto without departing from the scope of the appended claims.

What we claim is:

1. A method of producing an alloy including the steps of:
a) pressing a milled metal/metal oxide composite powder producing a powder compact, and
b) inserting the powder compact in an open die or an extrusion die, and, characterised by the steps of:
c) applying pressure to the powder compact, and
d) heating the powder compact in the die to the required temperature such that exothermic reactions between the metal and metal oxide in the powder compact is ignited, become self propagating and lead to formation of a mixture of alloy liquid and oxide solid, and
e) continuing to apply pressure to separate phases.

2. A method of producing an alloy as claimed in claim 1, characterised by the further step of milling the mixture to produce the metal/metal oxide composite powder.

3. A method of producing an alloy as claimed in claim 2, characterised by the further step of mixing a first metal and a second metal oxide powder with a controlled metal/metal oxide molar ratio to form a mixture to be milled.

4. A method of producing an alloy as claimed in claim 3, wherein the first metal is aluminium.

5. A method of producing an alloy as claimed in claim 3, wherein the second metal oxide powder is TiO₂.

6. A method of producing an alloy as claimed in any one of claims 3 to 5, wherein the first Al metal and the second TiO₂ metal oxide powder are mixed together with an Al/TiO₂ molar ratio.

7. A method of producing an alloy as claimed in any one of claims 1 to 6, wherein a reaction product is an intermetallic compound TiAl.

8. A method of producing an alloy as claimed in any one of claims 1 to 7, wherein a reaction product is an intermetallic compound Ti₃Al.

9. A method of producing an alloy as claimed in any one of claims 1 to 8, wherein a reaction product are metallic phases Ti(Al) solution and Al₂O₃.

10. A method of producing an alloy as claimed in claim 6, wherein the Al/TiO₂ molar ratio is controlled using the nominal reaction equation:
4Al+3T₂→3Ti+2Al₂O₃

11. A method of producing an alloy as claimed in claim 6, wherein the Al/TiO₂ molar ratio is controlled using the nominal reaction equation:
5Al+3TiO₂→Ti₃Al+2Al₂O₃

12. A method of producing an alloy as claimed in claim 6, wherein the Al/TiO₂ molar ratio is controlled using the nominal reaction equation:
7Al+3TiO₂→3TiAl+2Al₂O₃

13. A method of producing an alloy as claimed in any one of claims 1 to 12, wherein the mixture milled is converted into an Al/TiO₂ powder with particle sizes in the range of 0.1 μm-200 μm.

14. A method of producing an alloy as claimed in anyone of claims 1 to 13, wherein the milled Al/TiO₂ powder is pressed as per step a) into a powder compact using a die.

15. A method of producing an alloy as claimed in claim 14, wherein the shape and configuration of the powder compact is a cylinder of 40 mm in diameter and 40 mm in height.

16. A method of producing an alloy as claimed in claim 14 or claim 15, wherein the powder compact is placed in a die as per step b) and a pressure in the range of 0.01-15 MPa is applied to the compact.

17. A method of producing an alloy as claimed in any one of claims 1 to 16, wherein the die containing the powder compact is heated as per step d) to an elevated temperature in the range of 400° C.-1300° C.

18. A method of producing an alloy substantially as herein described with reference to and as illustrated by the accompanying micrographs and graphs.
